(19) United States
(12) Patent Application Publication
(10) Pub. No.: US 2009/0106496 A1
(43) Pub. Date: Apr. 23, 2009

(54) UPDATING CACHE BITS USING HINT TRANSACTION SIGNALS

(76) Inventor: Patrick KNEBEL, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/875,281

(22) Filed: Oct. 19, 2007

(51) Int. Cl. G06F 12/08

(52) U.S. Cl. 711/136; 711/133; 711/E12.022

(57) ABSTRACT

A system comprises processing logic that issues a request associated with an address. The system comprises a first cache that comprises a plurality of line frames. Each line frame has a status bit indicative of how recently that line frame has been accessed. The system comprises a second cache comprising another line frame having another status bit that is indicative of how recently the another line frame has been accessed. The another line frame comprises data other than the another status bit. If one of the plurality of line frames comprises the data associated with the address and the status bit associated with the one of the plurality of line frames is in a predetermined state, the first cache generates a hint transaction signal which is used to update the another status bit. The hint transaction signal does not cause the data to be updated.

### BACKGROUND

Computer systems often use caches and other memory local to the caches to store data during operation. Because caches are of finite sizes, each cache is associated with one or more replacement algorithms. In the event that a cache is full and some cache data needs to be removed to make space for new data, these replacement algorithms determine which cache data should be cleared and which cache data should remain in the cache. Replacement algorithms thus have a substantial impact on the efficiency of a cache system. Accordingly, improvements in cache replacement algorithms are desirable.

### BRIEF DESCRIPTION OF THE DRAWINGS

For a detailed description of exemplary embodiments of the invention, reference will now be made to the accompanying drawings in which:

FIG. 1 shows a block diagram of an illustrative cache system, in accordance with various embodiments;

FIG. 2 shows an illustrative line frame stored in the cache system of FIG. 1, in accordance with various embodiments;

FIG. 3 shows an illustrative cache architecture associated with the cache system of FIG. 1, in accordance with various embodiments; and

FIG. 4 shows a flow diagram of an illustrative method implemented in accordance with various embodiments.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, in the following discussion and in the claims, the term “couple” or “couples” is intended to mean either an indirect, direct, optical or wireless electrical connection. Thus, if a first device couples to a second device, that connection may be through a direct electrical connection or through an indirect electrical connection via other devices and connections. The term “processing logic” refers to any device, circuit logic, etc. that can access memory and/or a cache. Further, in the claims and in the description, when a cache is described as performing an action, it is meant that either the cache is performing the action alone, in combination with a cache controller, or that the cache controller is performing the action alone.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Disclosed herein is a technique by which a cache system comprising multi-level caches updates information used by a replacement algorithm of a low-level cache. In particular, the technique comprises determining whether a line in a high-level cache has been accessed. If that line has been accessed, the technique comprises sending a “hint transaction” (e.g., a signal) to a low-level cache to update status bits of the low-level cache.

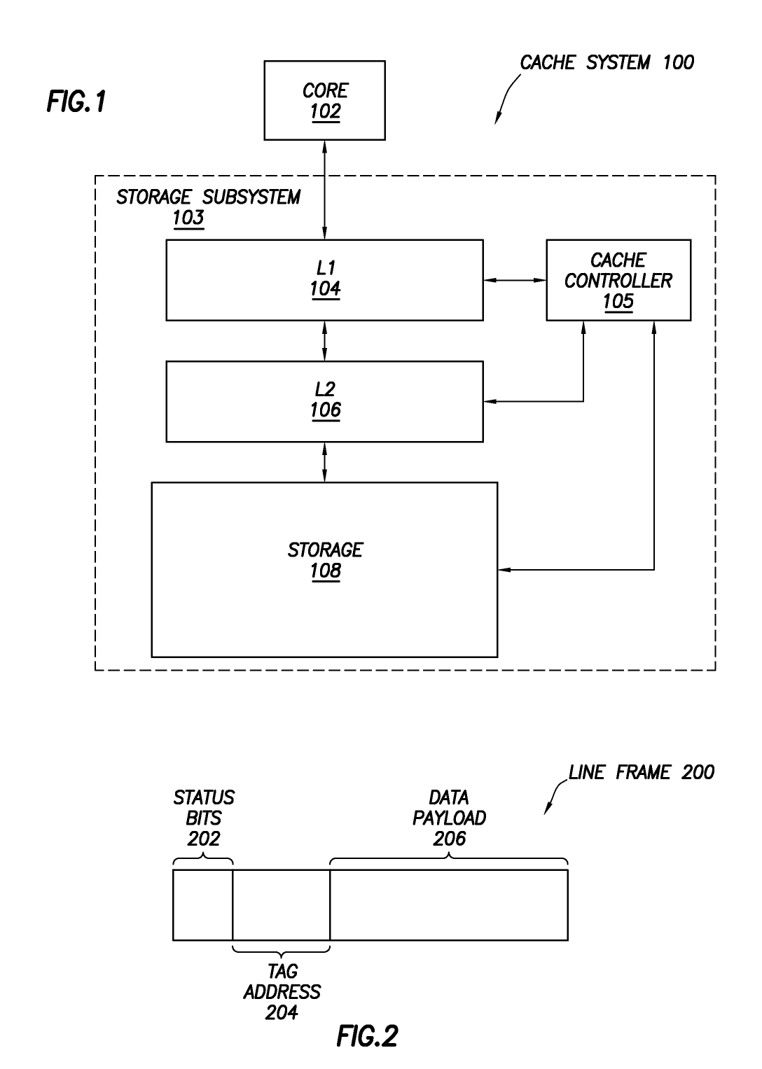

FIG. 1 shows a block diagram of an illustrative cache-based system 100. The system 100 may be implemented in any suitable electronic device, such as a computer (e.g., personal computer, server, gaming console, digital camera, digital music device, etc.). The system 100 comprises a processor core 102 (also referred to as “processing logic”). Although only one processor core is explicitly shown, it is understood that in some embodiments, multiple cores may be used. The core 102 couples to a storage subsystem 103 comprising first-level cache (“L1 cache”) 104. In turn, the L1 cache 104 couples to a second-level cache (“L2 cache”) 106. Because the L1 cache 104 is accessed more frequently by the core 102 than is the L2 cache 106, the L1 cache 104 is referred to as a “high level” cache and the L2 cache 106 is referred to as a “low level” cache. Caches in addition to the caches 104 and 106 also may be used. The L2 cache 106 couples to storage (e.g., random access memory (RAM), etc.) 108. The system 100 also comprises a cache controller 105 that controls the L1 cache 104, L2 cache 106 and storage 108.

The caches 104 and 106 store information that the core 102 frequently accesses from the storage 108. In this way, the speed of the core 102 is enhanced. In some embodiments, information stored in the cache 104 is accessed faster than is information stored in the cache 106. In some embodiments, information stored in the cache 106 is accessed faster than is information stored in the storage 108. For example, the core 102 may have a processor speed of 800 MHz, the L1 cache 104 may have an access speed of 800 MHz, the L2 cache 106 may have an access speed of 400 MHz, and the storage 108 may have an access speed of about 200 MHz.

When the core 102 requires data stored at a particular address in storage (e.g., as a result of executing a software application), the core 102 first determines whether the L1 cache 104 contains data associated with that address. If the address is found in the L1 cache 104 (a cache “hit”), the core 102 retrieves the data from the L1 cache 104 at that address. If the L1 cache 104 does not contain the address (a cache “miss”), the core 102 then determines whether the next-fastest cache, the L2 cache 106, contains the address. If a hit occurs in the L2 cache 106, the core 102 retrieves the data in the L2 cache 106 at that address. However, if a miss occurs in the L2 cache 106, the core 102 obtains the data from storage 108. Data obtained from the storage 108 is stored in the L1 cache 104, L2 cache 106 or both the caches 104 and 106 so that the data is available therefrom if the core 102 requires it.

The caches 104 and 106 comprise a plurality of “line frames” which may be used to store data and/or instructions (hereinafter collectively referred to as “data”) in addition to one or more addresses and one or more status bits. As shown in FIG. 2, a line frame 200 is a data structure that stores a predetermined amount of data 206 in addition to status bits 202 and a tag address 204 associated with the data 206. In at least some embodiments, a line frame may store approximately 32 bytes of data 206 known as a “line.” In other embodiments, an amount of data 206 stored per line frame 200 in one cache may differ from an amount of data stored per line frame in another cache. In some embodiments, the data 206 is stored in storage that is separate from that of the tag address and the status bits. In other embodiments, the data 206, the tag address 204 and the status bits 202 are stored in common storage.

In some embodiments, the status bits 202 indicate status information pertaining to the line 206. For example, the status bits 202 may indicate whether the line 206 in a line frame 200 is valid, and if valid, whether the line 206 is “dirty.” A line is considered to be “dirty” when the line has been updated with a data value which has not been used to update a corresponding line in a lower level memory. For example, if a line in an L1 cache is updated but a corresponding line in the L2 cache is not updated with the same value, the L1 cache line is dirty. The scope of disclosure is not limited to including any particular information in each line or line frame. In some embodiments, one or more of the line frames implement the MESI (i.e., Modified, Exclusive, Shared, Invalid) protocol or a modified version thereof.

The status bits 202 also may contain bits that are used by the corresponding cache's cache replacement algorithm. For example, the status bits 202 may contain one or more Not Recently Used (NRU) bits and/or Least Recently Used (LRU) bits. An NRU bit having status “0” indicates that the corresponding line has not been recently accessed (i.e., within a predetermined time interval). An NRU bit having status “1” indicates that the corresponding line has been recently accessed. In some embodiments, an NRU bit of “0” indicates a recent access and an NRU bit of “1” indicates lack of a recent access. Similarly, an LRU bit having status “0” indicates that the corresponding line is “least recently used,” or that the line has not been used within a predetermined time interval. An LRU bit having status “1” indicates that the corresponding line is “not least recently used,” or that the line has been used within a predetermined time interval. In some embodiments, an LRU bit of “0” indicates recent usage and an LRU bit of “1” indicates lack of recent usage. These types of status bits are used when determining which line(s) to evict when space is needed in the cache. The information contained in a line frame may be the same as, different than, similar to, less than or greater than that which is specifically disclosed herein. Other cache replacement algorithms are included within the scope of this disclosure.

Each line frame 200 in a cache is associated with a different address. An illustrative 32-bit address comprises a tag address (e.g., bits 31:14) such as tag address 204, a set address (e.g., bits 13:5) and an offset or NULL value (e.g., bits 4:0). Lines (and associated line frames) having a common set address are mapped into a group known as a “set.” Because lines within a set share a common set address, the lines within the set are distinguished from one another using the tag address of each line. Thus, if the core 102 accesses cache data stored at a particular 32-bit address, the core 102 uses the set address in bits 13:5 to locate a matching set in the cache, and then uses the tag address in bits 31:14 to locate a matching line within the set.

In accordance with various embodiments, each cache also has a specific number of “ways.” A collection of corresponding line frames across all sets in a cache is called a “way” in the cache. The number of ways in a cache also corresponds to the number of line frames present in each set of the cache. For instance, a two-way cache has two ways, and each set in the cache has two line frames associated with that set, where each of the two line frames is associated with one of the two ways. As a result, data to be allocated to a particular set has two possible line frame destinations.

In some embodiments, each cache stores various information pertaining to the line frames in that cache. For example, the line frames in a set may be ranked or ordered based on how recently each line frame was accessed. In some embodiments, the most recently accessed line frame (e.g., accessed for a data read or write) may be ranked first, and the least recently accessed line frame may be ranked last. Alternatively, the least recently accessed line frame may be ranked first, and the most recently accessed line frame may be ranked last. Such rankings may be termed “least recently used” (LRU) rankings, mentioned above. In operation, when new data is to be stored in a set, the LRU rankings may be used to determine which line frame was least recently accessed. The data in the line frame which was least recently accessed may be removed, or “evicted,” to make room for the new data to be stored in that line frame.

Although the scope of disclosure is not limited to any particular number of caches or type of cache, use of the LRU rankings to evict data preferably is performed in the context of set-associative caches. More specifically, a set-associative cache contains multiple line frames per set within which data from each lower-level memory location may be held. For example, in a two-way set associative cache, data from a single memory location in the L2 cache 106 may be stored in two locations in the L1 cache 104. Thus, when determining which of the two locations in the L1 cache 104 to store a data value from the L2 cache 106, the LRU ranking of the two locations is compared. In some embodiments, data in the location that is least-recently accessed is evicted to make room for the data value from the L2 cache 106. Other types of caches also may be used, such as direct-mapped caches and fully-associative caches. A direct-mapped cache comprises a single line frame per set within which data from a lower-level memory location may be held. A fully-associative cache enables the storage of a lower-level memory location into any line frame of the fully-associative cache.

FIG. 3 shows a detailed view of the L1 cache 104 and the L2 cache 106. As previously described, the L1 cache 104 comprises a plurality of line frames 308, 310, 312 and 314. Each line frame is associated with status bits 202, a tag address 204 and data payload (i.e., line) 206. The status bits 202 comprise NRU bits 300 and miscellaneous bits 302 (e.g., validity bits, etc.). The NRU bit 300 of each line frame indicates whether the line 206 associated with that line frame is “not recently used” or is “recently used.” As shown, some fields of the L1 cache 104 have been populated with illustrative values for purposes of this discussion. In particular, line frame 308 has an NRU bit 300 of “0” and a tag address 204 of “1111.” Line 310 has an NRU bit 300 of “0” and a tag address 204 of “1010.” Line 312 has an NRU bit 300 of “1” and a tag address 204 of “0010.” Line 314 has an NRU bit 300 of “1” and a tag address of “1110.”

Also as previously described, the L2 cache 106 comprises a plurality of line frames 316, 318, 320, 322, 324, 326, 328 and 330. Each of these line frames is associated with status bits 202, a tag address 204 and data payload (i.e., line) 206. The status bits 202 include NRU bits 304 and/or LRU bits 306. As mentioned, the NRU bit 304 of each line frame in the cache 106 indicates whether the line 206 associated with that line frame is “not recently used” or “recently used.” Similarly, the LRU bit 306 of each line frame in the cache 106 indicates whether or not the line 206 associated with that line frame was used recently.

As shown, some fields of the L2 cache 106 have been populated with illustrative values for purposes of this discussion. In particular, line frame 316 has an NRU bit 304 of “0” and an LRU bit 306 of “1” with a tag address 204 of “1111.” Line frame 318 has an NRU bit 304 of “0” and an LRU bit 306 of “0” with a tag address 204 of “0001.” Line frame 320 has an NRU bit 304 of “1” and an LRU bit 306 of “1” with a tag address 204 of “1010.” Line frame 322 has an NRU bit 304 of “1” and an LRU bit 306 of “0” with a tag address 204 of “0010.” Line frame 324 has an NRU bit 304 of “1” and an LRU bit 306 of “0” with a tag address 204 of “1110.” Line frame 326 has an NRU bit 304 of “1” with an LRU bit 306 of “0” with a tag address 204 of “0000.” Line frame 328 has an NRU bit 304 of “0” and an LRU bit 306 of “1” with a tag address 204 of “0011.” Line frame 330 has an NRU bit 304 of “0” and an LRU bit 306 of “0” with a tag address 204 of “0111.”

In accordance with various embodiments, the L1 cache 104 generates and sends a “hint transaction” to the L2 cache 106 whenever a “hit” is made in the L1 cache 104 and when the line frame that is “hit” has an NRU bit 304 indicating that the corresponding line 206 has not been recently accessed (e.g., accessed within a predetermined time frame). This hint transaction is used by the L2 cache 106 to update its status bits 202 (and, in some embodiments, other information may be updated as well). For example, the NRU and LRU bits of one or more line frames may be updated. In some embodiments, only the status bits 202, and not the data 206, are updated. The hint transaction is useful at least because status bits in lower-level caches, such as the L2 cache, are kept up-to-date.

For example, the core 102 may require data associated with the tag address “1110.” The core 102 may first search the L1 cache 104 for this tag address. Line frame 314 will be hit, because it is associated with the tag address “1110.” However, line frame 314 already has an NRU bit 314 of “1,” indicating that the line frame 314 has recently been accessed. Thus, no hint transaction is sent to the L2 cache 206 (due to, e.g., bandwidth limitations). However, in some embodiments, hint transactions may be sent even if the hit line frame 314 has recently been accessed. In some embodiments, a replacement algorithm different from the NRU algorithm can be implemented for line frame 314. The technique disclosed herein applies to any and all such suitable algorithms.

Continuing with the above example, the core 102 may require data associated with the tag address “1111.” The core 102 searches the L1 cache 104 and the line frame 308 is hit. Because the line frame 308 has an NRU bit 314 of “0,” indicating that the line 206 associated therewith has not been accessed recently, the L1 cache 104 updates the NRU bit 314 from “0” to “1,” thereby indicating from that point on that the line 206 has been recently accessed. Further, the L1 cache 104 sends a hint transaction (e.g., message, signal, etc.) to the L2 cache 106 that causes the L2 cache 106 to update one or more of its status bits. In some embodiments, the hint transaction signal causes the L2 cache 106 to locate the line frame 316 having tag address “1111” and causes the L2 cache 106 to update the NRU bit 304 and LRU bit 306. Specifically, the NRU bit 304 may be updated from “0” to “1” (or, in some embodiments, vice versa) to reflect the fact that the data associated with the tag address “1111” has recently been accessed (from the L1 cache 104). Further, the LRU bit 306 may be updated from “1” to “0” (or, in some embodiments, vice versa) to reflect the fact that the data associated with the tag address “1111” has recently been accessed. In some embodiments, only one of the NRU/LRU algorithms is implemented, and so only one bit is updated in such embodiments. Various combinations of replacement algorithms may be implemented in the L1 cache 104 and/or L2 cache 106. The techniques disclosed herein may be applied regardless of the replacement algorithm used.

In some embodiments, when a predetermined number of NRU bits 300 in the L1 cache 104 have a status of “0,” indicating that the corresponding lines have not been recently accessed, the L1 cache 104 adjusts those predetermined NRU bits 300 to “1” (or, in other embodiments, vice versa). In some embodiments, if a cache line frame is replaced in the L1 cache 104, no hint transaction is sent to the L2 cache 106, regardless of the NRU bit status of that replaced cache line frame.

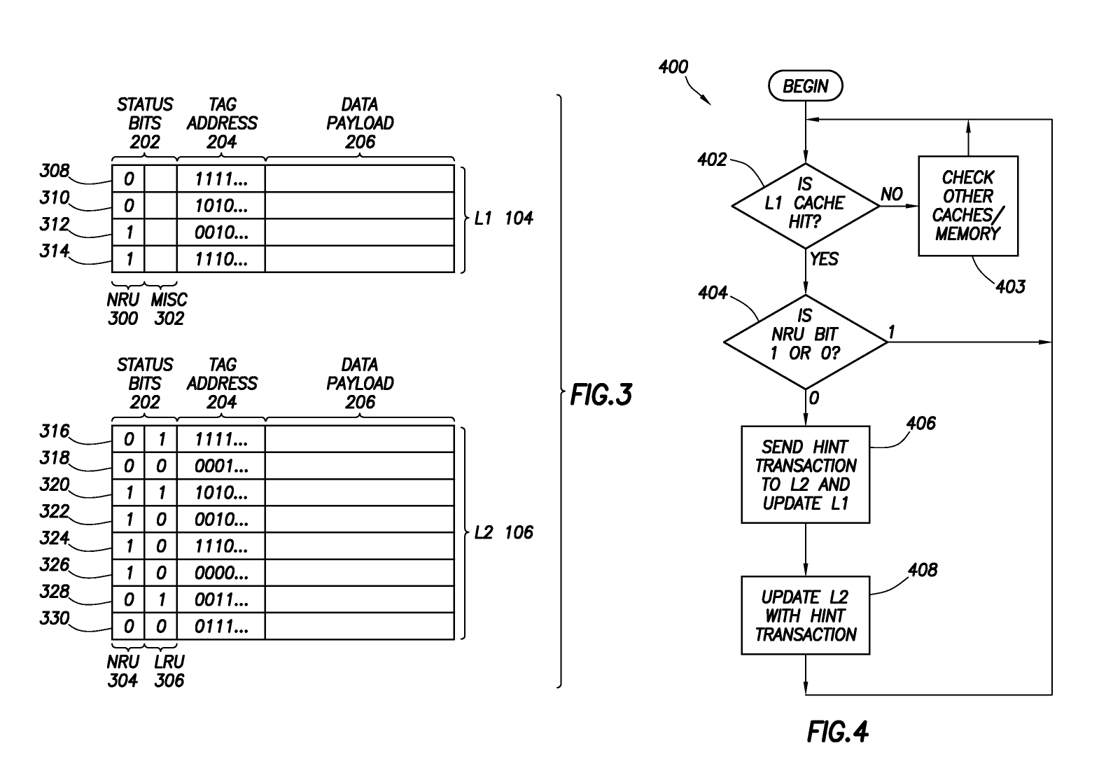

FIG. 4 shows a flow diagram of an illustrative method 400 implemented in accordance with various embodiments. The method 400 begins by determining whether a line frame in the L1 cache has been hit (block 402). If not, the method 400 comprises checking another cache, storage, etc. to determine whether the address can be located (block 403). Otherwise, the method 400 continues by determining whether the NRU bit of the hit line frame indicates that the line frame has been recently accessed or not (block 404). If the line frame has not been recently accessed, the method 400 comprises updating the NRU bit of the hit line frame and sending a hint transaction to the L2 cache (block 406). The method 400 then comprises updating the L2 cache status bits using the hint transaction (block 408).

The techniques described herein may be applied to all appropriate cache systems, regardless of the number of cores and caches included therein. The techniques may be adapted to suit any combination of cache replacement algorithms implemented in one or more caches. In at least some embodiments, the techniques are implemented in inclusive cache systems, where a lower-level cache contains most or all data contained in a higher-level cache.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A system, comprising:
processing logic that issues a request associated with an address;
a first cache coupled to the processing logic and comprising a plurality of line frames, each line frame having a status bit indicative of how recently that line frame has been accessed; and
a second cache coupled to the first cache and comprising another line frame having another status bit that is indicative of how recently the another line frame has been accessed, the another line frame comprising data other than said another status bit;
wherein, if one of the plurality of line frames comprises the data associated with the address, and based on the status bit associated with said one of the plurality of line frames being in a predetermined state, the first cache generates a hint transaction signal;
wherein the second cache updates said another status bit based on said hint transaction signal;
wherein the hint transaction signal does not cause said data to be updated.

2. The system of claim 1, wherein the first cache comprises a cache of a higher level than the second cache.

3. The system of claim 1, wherein the first cache implements a Not Recently Used (NRU) cache replacement algorithm.

4. The system of claim 1, wherein the another status bit comprises either a Not Recently Used (NRU) bit or a Least Recently Used (LRU) bit.

5. The system of claim 1, wherein the system comprises a computer.

6. The system of claim 1, wherein said predetermined state indicates that said one of the plurality of line frames was accessed less recently than a different one of said plurality of line frames.

7. The system of claim 1, wherein the first and second caches together constitute an inclusive cache system.

8. A method, comprising:
determining whether a cache hit occurred in a first cache;
if said cache hit occurred, determining whether said cache hit occurred in a line frame of said first cache that has been accessed less recently than another line frame of said first cache;
based on said determination, transferring a hint transaction signal from the first cache to a second cache; and
updating a status bit in one of a plurality of line frames in the second cache in accordance with said hint transaction signal.

9. The method of claim 8, wherein determining whether said cache hit occurred in the line frame of said first cache comprises using a Not Recently Used (NRU) bit.

10. The method of claim 8, wherein the first cache is of a higher level than the second cache.

11. The method of claim 8 further comprising, if said cache hit occurred in the line frame of said first cache that has been accessed less recently than another line frame of said first cache, adjusting a bit associated with said line frame of the first cache.

12. The method of claim 8, wherein said status bit comprises either a Not Recently Used (NRU) bit in the second cache or a Least Recently Used (LRU) bit.

13. The method of claim 8, wherein determining whether the cache hit occurred in the first cache comprises using a first cache stored in a computer.

14. The method of claim 8, further comprising not updating data other than the status bit in said one of a plurality of line frames as a result of the hint transaction signal.

15. A system, comprising:
means for determining whether a cache hit occurred in a line frame of a first cache and whether said line frame has been accessed less recently than another line frame of said first cache;
means for transferring a hint transaction signal from the first cache to a second cache based on said determination; and
means for updating a status bit of one of a plurality of line frames in a second cache in accordance with said hint transaction signal, wherein said status bit indicates whether said one of the plurality of line frames has been accessed less recently than a different line frame in the second cache;
wherein the hint transaction signal does not cause data other than said status bit in said one of a plurality of line frames to be updated.

16. The system of claim 15, wherein the means for transferring transfers the hint transaction signal only if the cache hit occurs and only if the line frame has been accessed less recently than said another line frame.

17. The system of claim 15, wherein the system comprises an inclusive cache system.

18. The system of claim 15, wherein the second cache is of a lower level than the first cache.

19. The system of claim 15, wherein said status bit comprises either a Not Recently Used (NRU) bit or a Least Recently Used (LRU) bit.

20. The system of claim 15, wherein the system comprises a computer.
